(19) United States
(12) Patent Application Publication
(10) Pub. No.: US 2015/0302423 A1
(43) Pub. Date: Oct. 22, 2015

(54) METHODS AND SYSTEMS FOR CATEGORIZING USERS

(71) Applicant: Xerox Corporation, Norwalk, CT (US)

(72) Inventors: Veerasundaravel Thirugnanasundaram, Webster, NY (US); Udhayakumar Dhanabalan, Madurai (IN); Tong Sun, Penfield, NY (US); David R. Vandervort, Walworth, NY (US); Arun Bakthavachalu, Webster, NY (US)

(73) Assignee: Xerox Corporation, Norwalk, CT (US)

(21) Appl. No.: 14/254,993

(22) Filed: Apr. 17, 2014

(51) Int. Cl. G06Q 30/02; G06Q 50/00

(52) U.S. Cl. CPC G06Q 30/0201; G06Q 50/01; G06Q 30/0282

(57) ABSTRACT

Methods and systems for categorizing users. A first set of communities and a second set of communities are identified based on a set of keywords and one or more messages posted by at least the users on one or more websites. The first set of communities corresponds to at least one of a product or a service, and second set of communities corresponds to at least one of a competitor-product or a competitor-service. The one or more conversations associated a user in at least one of the first set of communities or the second set of communities are determined. The one or more conversations correspond to exchange of messages at least between the user and a user-representative. The one or more conversations are analyzed to obtained one or more attributes. The users are categorized based on the one or more attributes.

### TECHNICAL FIELD

The presently disclosed embodiments are related, in general, to a customer relationship management (CRM) system. More particularly, the presently disclosed embodiments are related to methods and systems for categorizing users in the CRM system, based on the sentiments of the users.

### BACKGROUND

Customer relationship management (CRM) refers to a model for managing the relationship between an organization and its users/clients. Organizations may use the CRM to strengthen the relationship with their users. For example, organizations use the CRM to retain existing users by providing resolutions to the issues faced by the users or by providing additional offers/services to the users. Further, CRM is a closed loop process in which feedback from the users may be used to modify processes in the organizations.

With the rise of the social networking and micro-blogging services like Twitter, Facebook, etc., the organizations may want to know the opinions, reviews, recommendations, and the like about a service or a product, shared by the users on these social services to manage their users better. For example, users associated with various products/services use different social networking sites (e.g., Facebook, Twitter, etc.) to talk their experience, or to seek/share recommendations for these products/services. Typically, user-representatives of the various organizations use these social mediums to listen, understand, or resolve the user's issues. However, understanding different categories of the users so that different users can be targeted differently, as per their needs, has been a non-trivial problem for the organizations.

### SUMMARY

According to embodiments illustrated herein, there is provided a method for categorizing users in one or more categories. The method includes identifying a first set of communities and a second set of communities based on a set of keywords and one or more messages posted by at least the users on one or more websites. The first set of communities corresponds to at least one of a product or a service. The second set of communities corresponds to at least one of a competitor-product or a competitor-service. The method further includes determining one or more conversations associated with a user in at least one of the first set of communities or the second set of communities, based on the one or more messages. Each of the one or more conversations corresponds to exchange of the one or more messages at least between the user and a user-representative. The method further includes categorizing the user in at least one category, from the one or more categories, based on one or more attributes determined from the one or more conversations. The one or more attributes comprise at least one of a happiness score associated with the user, a conversation subject associated with the user, a social influence metric associated with the user, or a geographic location associated with the user. Further, the happiness score is determined based on at least one of a start and end of the one or more conversations, a number of the one or more messages in each of the one or more conversations, time taken by the user-representative to reply to the one or more messages posted by the user, time taken by the user-representative to resolve the one or more issues, or a status of the one or more issues. The method is performed by the one or more processors.

According to embodiments illustrated herein, there is provided a system for categorizing users in one or more categories. The system includes one or more processors configured to identify a first set of communities and a second set of communities based on a set of keywords and one or more messages posted by at least the users on one or more websites. The first set of communities corresponds to at least one of a product or a service. The second set of communities corresponds to at least one of a competitor-product or a competitor-service. The one or more processors are further configured to determine one or more conversations associated with a user in at least one of the first set of communities or the second set of communities, based on the one or more messages. Each of the one or more conversations corresponds to exchange of the one or more messages at least between the user and a user-representative. The one or more processors are further configured to categorize the user in at least one category, from the one or more categories, based on one or more attributes determined from the one or more conversations. The one or more attributes comprise at least one of a happiness score associated with the user, a conversation subject associated with the user, a social influence metric associated with the user, or a geographic location associated with the user. Further, the happiness score is determined based on at least one of a start and end of the one or more conversations, a number of the one or more messages in each of the one or more conversations, time taken by the user-representative to reply to the one or more messages posted by the user, time taken by the user-representative to resolve the one or more issues, or a status of the one or more issues.

According to embodiments illustrated herein, there is provided a computer program product for use with a computer. The computer program product includes a non-transitory computer readable medium. The non-transitory computer readable medium stores a computer program code for categorizing users in one or more categories. The computer program code is executable by one or more processors to identify a first set of communities and a second set of communities based on a set of keywords and one or more messages posted by at least the users on one or more websites. The first set of communities corresponds to at least one of a product or a service. The second set of communities corresponds to at least one of a competitor-product or a competitor-service. The computer program code is further executable by the one or more processors to determine one or more conversations associated with a user in at least one of the first set of communities or the second set of communities, based on the one or more messages. Each of the one or more conversations corresponds to exchange of the one or more messages at least between the user and a user-representative. The computer program code is further executable by the one or more processors to categorize the user in at least one category, from the one or more categories, based on one or more attributes determined from the one or more conversations. The one or more attributes comprise at least one of a happiness score associated with the user, a conversation subject associated with the user, a social influence metric associated with the user, or a geographic location associated with the user. Further, the happiness score is determined based on at least one of a start and end of the one or more conversations, a number of the one or more messages in each of the one or more conversations, time taken by the user-representative to reply to the one or more messages posted by the user, time taken by the user-representative to resolve the one or more issues, or a status of the one or more issues.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram illustrating a system for categorizing the users in one or more categories, in accordance with at least one embodiment;

FIG. 3 is a flowchart illustrating a method for categorizing the users in one or more categories, in accordance with at least one embodiment; and

FIG. 4 is a flow diagram illustrating categorization of the users, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “Computing device” may refer to a device that includes a processor/microcontroller and/or any other electronic component, or a device or a system that performs one or more operations according to one or more programming instructions. Examples of the computing device include, but are not limited to, a desktop computer, a laptop, a personal digital assistant (PDA), a mobile phone, a smart-phone, a tablet computer, and the like.

A “product” may refer to a commodity used by a user. The product may include various types of commodities such as, but not limited to, electronic devices, computing devices, media devices, Fast moving consumer goods (FMCG), and the like. In an embodiment, a product may have one or more competitor-products in a business marketplace.

A “service” may refer to an intangible commodity that may be utilized by the user. Organizations may provide different types of services, such as, but not limited to, business processing services, customer care services, knowledge processing services, communication services, and the like. In an embodiment, the business marketplace may include one or more competitor-services corresponding to a service provided by an organization.

“One or more communities” may refer to groups of the users. Users of various products/services may be grouped in the one or more communities. In an embodiment, the one or more communities may include a first set of communities and a second set of communities. The first set of communities may include the users associated with product/service, and the second set of communities may include the users associated with competitor-product/competitor-service.

A “set of keywords” may refer to a set of words, letters, phrases, sentences, and the like that correspond to at least one of the products/services, or the competitor-products/competitor-services. In an embodiment, the keywords may include a first set of keywords and a second set of keywords. The first set of keywords may correspond to a product/service, and the second set of keywords may correspond to the competitor-product/competitor-service.

“One or more websites” correspond to information hosted on computing devices interconnected by a network (e.g., a local area network (LAN), a metropolitan area network (MAN), a wide area network (WAN) etc.). In an embodiment, the one or more websites hosted on a computing device may be accessed through other computing devices. In an embodiment, the one or more websites may include at least one of one or more social networking websites (e.g., Facebook, Twitter, Google+, Pinterest, etc.), a website associated with the product/service, a website associated with the competitor-product/competitor-service, or a blogging website. Further, the one or more websites may include various types of the information, posted by at least the users, pertaining to the product/services, or competitor-product/competitor-service.

A “message” may refer to a series of words, phrases, sentences, emoticons, etc., posted by at least the users on the one or more websites. For example, the one or more users may post the one or more messages for sharing the recommendations, reviews, opinions, one or more issues etc. about the products/services, or competitor-products/competitor-services. In an embodiment, the messages may correspond to one or more messages posted by a user-representative. For example, the user-representative may reply to the one or more messages posted by the users on the one or more websites. The messages posted by the user-representative may include recommendations provided to the users for resolving the one or more issues. A person having ordinary skill in the art would understand that scope of the disclosure should not be limited to extracting the messages from the one or more websites. In an embodiment, the messages may be extracted from the emails/fax exchanged between a user and a user-representative. Further, the organizations may receive feedback from the users on hardcopies. In such a scenario, the hardcopies may be scanned and analyzed to extract the one or more messages.

A “conversation” may refer to a group of the one or more messages. In an embodiment, the exchange of the one or more messages posted by a user and a user-representative may be aggregated to form a conversation. In another embodiment, the messages exchanged between a user and other users may be grouped to form the conversations.

An “attribute” may refer to a parameter (or metric) associated with the user. In an embodiment, the attribute is determined by performing natural language processing on the one or more conversations in which the user is involved. Examples of the one or more attributes may include, but are not limited to, a happiness score associated with the user, a conversation subject associated with the user, a social influence metric associated with the user, or a geographic location associated with the user.

A “happiness score” may refer to a metric that is indicative of the satisfaction of the users in using the product/service, or the competitor-product/service. In an embodiment, the one or more conversations may be analyzed to determine how well the conversation happened that involves the user. That means, how well the conversation happened between the user and other users, or between the user and the user-representative. In an embodiment, the happiness score may be determined based on at least one of a start and end of the one or more conversations, a number of the one or more messages in each of the one or more conversations, time taken by the one or more user-representatives, or other users, to reply to the one or more messages posted by the user, time taken by the one or more user-representatives to resolve the one or more issues, or a status of the one or more issues (e.g., resolved/unresolved). In an embodiment, the happiness score may be a numerical value that ranges from −2 to +2, wherein −2 corresponds to least satisfied (i.e., the least happy) user, and +2 corresponds to most satisfied (i.e., the happiest) user.

A “conversation subject” may refer to a topic of the conversation that happened between the user and other users, or between the user and the user-representative. In an embodiment, the conversation subject may be determinable of the one or more reasons for the happiness or the unhappiness of the user.

A “social influence metric” may refer to a metric that is indicative of user's influence on other users. For example, the social influence metric corresponding to a user may refer to influence of the user, through the one or more messages, on other users about opinions on a product/service. In an embodiment, the social influence metric may correspond to activeness of the user in posting the one or more messages on the one or more websites.

A “category” may refer to a classification of a user based on the one or more attributes. In an embodiment, the users associated with a product/service, or a competitor-product/competitor-service may be classified into different categories, such as, but not limited to, happy users, disgruntled users, etc.

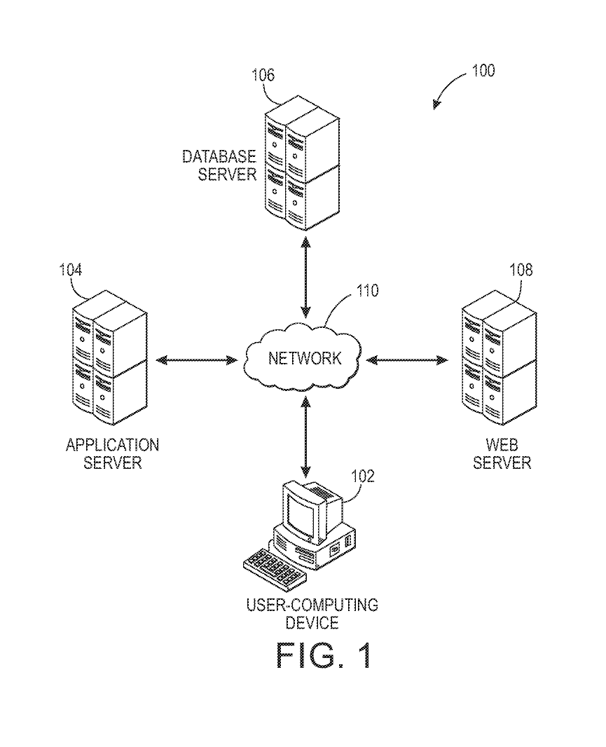

FIG. 1 is a block diagram illustrating a system environment 100 in which various embodiments can be implemented. The system environment 100 includes a user-computing device 102, an application server 104, a database server 106, a web server 108, and a network 110. In an embodiment, the one or more components of the system environment 100 (i.e., the user-computing device 102, the application server 104, the database server 106, and the web server 108) are interconnected through the network 110.

The user-computing device 102 refers to a computing device used by a user, who may post one or more messages on the one or more websites. In an embodiment, the user may access the web server 108 to post the messages. As disclosed, the one or more messages may correspond to review, recommendations, opinions, etc. about a product/service, or about a competitor-product/competitor-service. The user-computing device 102 may include a variety of computing devices, such as a desktop, a laptop, a personal digital assistant (PDA), a tablet computer, and the like.

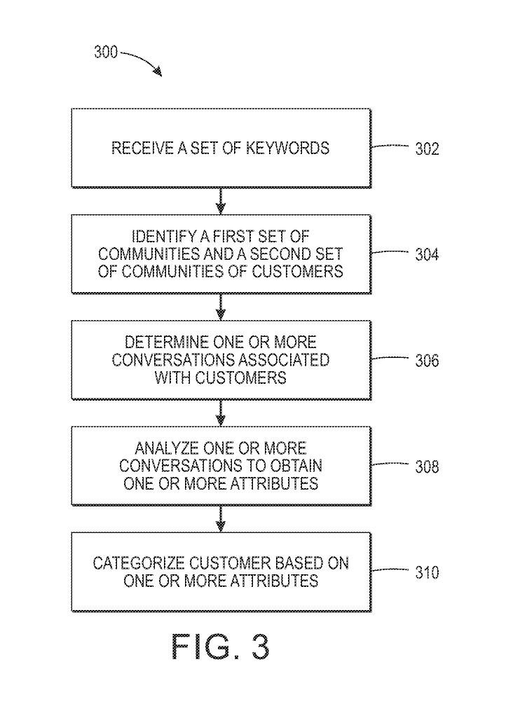

The application server 104 refers to a computing device that hosts the application/tool/framework for categorizing the users. In an embodiment, a CRM official may access (e.g., through a client application provided by the application server 104 or through a web interface) the application server 104 to obtain the list of categorized users. In an embodiment, the application/tool/framework installed on the application server 104 may determine one or more communities (i.e., the first set of communities and the second set of communities) based on a set of keywords and the one or more messages posted by at least the users. The application server 104 may collect the one or more messages posted by the users from the web server 108. Similarly, the application server 104 may collect the one or more messages posted by the user-representatives. Thereafter, the application server 104 may consolidate the one or more messages to generate the one or more conversations. Subsequently, the application server 104 may analyze the one or more conversations to determine the one or more attributes associated with each user in each community. The application server 104 may further utilize the one or more attributes to categorize the users in each community in the one or more categories (e.g., happy users, disgruntled users etc.). Further details about the categorization of the users in the one or more categories have been disclosed in conjunction with FIG. 3. In an embodiment, the application server 104 may store the one or more collected messages, the one or more generated conversations, the one or more determined attributes, and the one or more determined categories in the database server 106. The application server 104 may be realized through various types of application servers such as, but not limited to, Java application server, .NET framework, and Base4 application server.

The database server 106 refers to a computing device that may store the one or more messages collected by the application server 104. Further, the database server 106 may store the one or more conversations, the one or more attributes, and the one or more categories associated with the users. In an embodiment, the database server 106 may receive a query from the application server 104 to retrieve the data stored on the database server 106. For querying the database server 106, one or more querying languages may be utilized such as, but are not limited to, SQL, QUEL, DMX and so forth. Further, the database server 106 may be realized through various technologies, such as, but not limited to, Microsoft® SQL server, Oracle, and My SQL, and may be connected to application server 104, using one or more protocols such as, but not limited to, ODBC protocol and JDBC protocol.

It will be apparent to a person skilled in the art that the functionalities of the database server 106 may also be incorporated in the application server 104, without departing from the scope of the disclosure. In such a scenario, different types of the information (e.g., the one or more messages, the one or more conversations, the one or more attributes, and the one or more categories) may be stored in the application server 104.

The web server 108 refers to a computing device that hosts the one or more websites. In an embodiment, the users may access the web server 108 (through the user-computing device 102) to post the one or more messages on the one or more websites hosted on the web server 108. In a similar way, the user-representatives may access the web server 108 to post the one or more messages. It will be apparent to a person skilled in the art that though, for illustration purposes, only one web server 108 has been shown in the FIG. 1, the one or more websites may be hosted on more than one web servers. The web server 108 may be realized through various types of application servers such as, but not limited to, Java application server, .NET framework, and Base4 application server.

The network 110 corresponds to a medium through which content and messages flow between various devices of the system environment 100 (e.g., the user-computing device 102, the application server 104, the database server 106, and the web server 108). Examples of the network 110 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 110 in accordance with the various wired and wireless communication protocols such as Transmission Control Protocol and Internet Protocol (TCP/IP), User Datagram Protocol (UDP), and 2G, 3G, or 4G communication protocols.

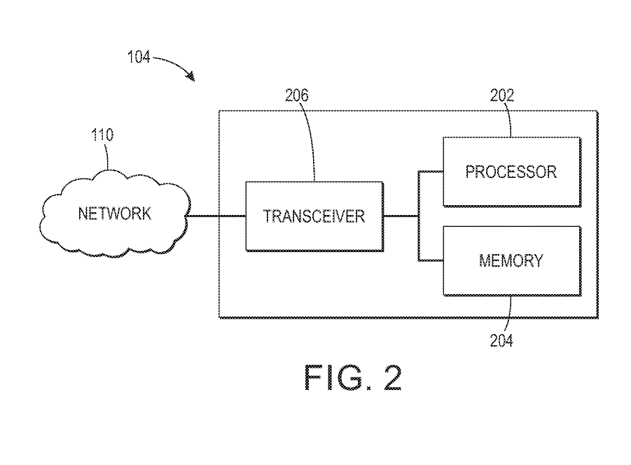

FIG. 2 is a block diagram illustrating the application server 104, in accordance with at least one embodiment. The application server 104 includes a processor 202, a memory 204, and a transceiver 206.

The processor 202 is coupled to the memory 204 and the transceiver 206. The processor 202 includes suitable logic, circuitry, and/or interfaces that are operable to execute one or more instructions stored in the memory 204 to perform predetermined operation. The memory 204 may be operable to store the one or more instructions. The processor 202 may be implemented using one or more processor technologies known in the art. Examples of the processor 202 include, but are not limited to, an X86 processor, a RISC processor, an ASIC processor, a CISC processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person having ordinary skills in the art that the one or more instructions stored in the memory 204 enables the hardware of the application server 104 to perform the predetermined operation.

The transceiver 206 transmits and receives messages and data to/from various devices of the system environment 100. Examples of the transceiver 206 may include, but are not limited to, an antenna, an Ethernet port, a USB port or any other port that can be configured to receive and transmit data. The transceiver 206 transmits and receives data/messages in accordance with the various communication protocols, such as, TCP/IP, UDP, and 2G, 3G, or 4G communication protocols. Operation of the application server 104 has been described in conjunction with FIG. 3.

FIG. 3 is a flowchart 300 illustrating a method for categorizing the one or more users, in accordance with at least one embodiment. The flowchart 300 is described in conjunction with FIG. 1 and FIG. 2.

At step 302, a set of keywords is received. The processor 202 may receive the set of keywords. In an embodiment, the set of keywords may include a first set of keywords and a second set of keywords. The first set of keywords may correspond to a product/service, and the second set of keywords may correspond to a competitor-product/competitor-service. For example, the first set of keywords may correspond to Apple-Iphone®, and the second set of keywords may correspond to the competitor products of Apple-Iphone®, such as Samsung-Galaxy®, Nokia-Lumia®, etc. In an embodiment, the processor 202 may receive the set of keywords through an input device (e.g., a keyboard, mouse, touch-interface, etc.) associated with the application server 104. In an embodiment, the processor 202 may present a graphical user interface (GUI) to the CRM official, and subsequently the CRM official may provide the set of keywords. Table 1 illustrates a set of keywords provided by the CRM official:

TABLE 1
Illustration of the set of keywords associated
with a product and its competitor-product

| Product/Competitor-product | Set of keywords |
|---|---|
| Apple-Iphone ® | Apple, iphone, IOS, Mobile |
| Sony-Xperia ® | Sony-Ericsson, Sony, Xperia, Phone, Mobile |
| Nokia-Lumia ® | Nokia, Mobile, Lumia, Windows 8 |
| Samsung-Galaxy ® | Samsung, Mobile, Phone, Galaxy |

As can be observed from the Table 1, different keywords may be inputted by the CRM official for a product and its competitor-product. It will be apparent to a person skilled in the art that various different keywords (not exemplified above) may also be added, without limiting the scope of the invention.

At step 304, a set of communities including a first set of communities and a second set of communities is identified. The processor 202 may identify the first set of communities based on the first set of keywords and the second set of communities based on the second set of keywords, received in conjunction with the step 302. That is, the first set of communities correspond to a product/service, and the second set of communities correspond to competitor-product/competitor-service. For example, referring to Table 1, the processor 202 may determine a first community of the users for Apple-Iphone® and one or more second communities of the users corresponding to Sony-Xperia®, Nokia-Lumia®, and Samsung-Galaxy®. In an embodiment, based on the social activities of the users (e.g., posting the one or more messages, joining a discussion group, a research group, a social network, etc.), the processor 202 may identify the set of communities. For example, the processor 202 may determine that a user has a friendship link with another user on Twitter® account. Similarly, the processor 202 may determine that the user has joined a research group (e.g., related to data mining) on ACM®. The processor 202 may utilize such information to group the users into the one or more communities. In an embodiment, the processor utilizes the one or more messages posted by the users to group the users in the one or more communities. For example, the processor 202 determine a post of a user on Facebook “Finally Iphone!!!”. The processor 202 may utilize such information to group the user into the first community (i.e., corresponding to Apple-Iphone). A person having ordinary skill in the art would understand that the scope of the disclosure should not be limited to analyzing the posts on the social networking web sites. In an embodiment, posts on blogs, customer-care forums, technical forums (such as XDA developers), etc. may also be analyzed to determine the community. In a similar way, the processor 202 may determine second set of communities based on the one or more messages.

In an embodiment, the processor 202 may determine the interests of the users and those of the communities, simultaneously, using a probabilistic graphic topic model. In this way, the messages posted by the users that are not related to interests of the communities may be neglected, such that the identified one or more communities better reflect the interests of the users. In an embodiment, the identified set of communities may be presented to the CRM official in ranked order, with the most relevant communities ranked higher.

Table 2 illustrates a ranked list of communities associated with a product/service and its competitor-product/competitor-service, as determined by the processor 202:

TABLE 2
Illustration of the ranked communities

| Rank | Communities |
|---|---|
| 1 | Cᵢ, Cᵢ₊₁, Cᵢ₊₂ . . . C_{i+w} |
| 2 | Cⱼ, Cⱼ₊₁, Cⱼ₊₂ . . . Cⱼ₊ₓ |
| 3 | Cₖ, Cₖ₊₁, Cₖ₊₂ . . . C_{k+y} |
| 4 | Cₗ, Cₗ₊₁, Cₗ₊₂ . . . C_{l+z} |

where, Cᵢs included in the communities denote the one or more users. It will be apparent to a person skilled in the art that a user may be a part of more than one community. For example, a user may be using both products, Apple-Iphone® and Samsung-Galaxy®, and may have posted the one or more messages corresponding to both the products on the one or more websites. In such a scenario, the user may be part of both the communities (i.e., corresponding to Apple-Iphone® and to Samsung-Galaxy®), without limiting the scope of the disclosure.

In an embodiment, the U.S. patent application Ser. No. 13/836,233, filed on Mar. 15, 2013, and assigned to the same assignee (Xerox Corporation), and which herein incorporated by reference in its entirety discloses an example method for determining the one or more communities based on the set of keywords.

At step 306, the one or more conversations associated with the users are determined. The processor 202 may extract the one or more messages posted by the users on the one or more websites to determine the one or more conversations. In an embodiment, the processor 202 determines the one or more messages exchanged between the users in same community. For example, the processor 202 may determine the one or more messages exchanged between a user in the community for “Apple-Iphone” and other users in the community “Apple-Iphone”. In an alternate embodiment, the processor 202 may extract the one or more messages exchanged between users of different communities. For example, the processor 202 may extract the messages exchanged between a user from the community for “Apple-Iphone” and other users from the community for “Samsung Galaxy”. In addition, the processor 202 may extract the one or more messages exchanged between the user and the user-representative. Thereafter, the processor 202 may combine these extracted messages into the one or more conversations. In an embodiment, corresponding to each user in a community, the processor 202 may determine the one or more conversations.

In an alternate embodiment, the processor 202 extracts the one or more messages from the emails/fax exchanged between the user and the user-representative. The processor 202 may aggregate these messages to determine the one or more conversations. In addition, the user may provide feedback to the organizations on hard-copies (e.g., in the feedback forms provided by the organizations). The processor 202 may extract the feedback provided by the user from scanned copies of such documents to determine the one or more conversations. As disclosed, the processor 202 may store the one or more messages and the one or more conversations in the database server 106.

At step 308, the one or more conversations are analyzed. In an embodiment, the processor 202 may analyze the one or more conversations using natural language processing. The processor 202 may analyze the one or more conversations to obtain the one or more attributes: the happiness score associated with the user, a conversation subject associated with the user, a social influence metric associated with the user, and a geographic location associated with the user.

In an embodiment, the happiness score associated with the user is indicative of the satisfaction of the user in using a product/service. The processor 202 may determine the happiness score for each of the users based on the analysis of the one or more conversations associated with the respective user. In an embodiment, the processor 202 determines a happiness score for each conversation, from the one or more conversations, associated with a user, and subsequently determines a cumulative happiness score of the user based on individual happiness scores of different conversations. In an embodiment, the conversation associated with the user corresponds to messages exchanged between the user and others users. For example, a user may post the message “Finally Iphone 5C!!”. Another user may reply with “Yes, yet another master-piece from Apple”. In such a scenario, the processor 202 may analyze these message to determine the happiness score. Similarly, the processor 202 may analyze the messages exchanged between users from different communities. For example, in reply to first message posted by the user (i.e., “Finally Iphone”), a user may reply with “But, still Samsung has far better features”. In such a scenario, the processor 202 may utilize these messages to determine the happiness score of the users. The processor 202 may determine the happiness score based on a number of factors, such as, but not limited to, a start and end of the conversation, a number of messages included in the conversation, time taken by the user-representative to reply to the one or more messages posted by the user, time taken by the user-representative to resolve the one or more issues raised by the user, a status of the one or more issues, and the like. It will be understood by a person skilled in the art that all of these parameters, based on which the happiness score is determined, represent how well the exchange of the messages that involves the user. In an embodiment, the happiness score associated a user is a numerical value that ranges from −2 to +2, such that −2 represents the least happy/least satisfied user, and +2 represents the happiest/most satisfied user. It will be apparent to a person skilled in the art that all of these factors may not be available in each of the conversations. For example, if the conversation corresponds to messages exchanged between the user and other users, time to resolve the one or more issues, time taken to reply to the one or more messages posted by the users, etc. may not be applicable.

In an embodiment, the conversation subject associated with the user is determinable of one or more reasons for the happiness or unhappiness of the user. The processor 202 may determine the conversation subject based on the analysis of the messages that include the user. In an embodiment, the processor 202 may filter out unwanted words to form a collective title of the conversations. For example, if the conversation between the user and the user-representative is regarding the mobile recharging issues faced by the users, then the processor 202 may determine the subject of the conversations, such as “mobile recharge failure”, “recharge coupon invalidity”, “recharge validity extension request”, and the like. Similarly, if the conversation between the user and others users (from same or other communities) is regarding the display problems in the mobile device, then the processor 202 may determine the subject of the conversation, such as “Mobile phone display problems”, etc.

In an embodiment, the social influence metric associated with the user is indicative of influence of the user, through the one or more messages posted by him/her, on the other users. In an alternate embodiment, the social influence metric associated with the user corresponds to the activeness of the user in posting the one or more messages on the one or more websites. The processor 202 may determine the social influence metric associated with the user based on the tools/applications, such as Klout®, PeerIndex®, Traackr®, and the like, which are known in the art. For example, Klout® determines the social influence of the users in terms of three specific features (i.e., “true reach”, “amplification”, and “network impact”). “True reach” is indicative of the size of user's social network (e.g., number of followers, friendship links, etc.). “Amplification” denotes the likelihood of generating action by other users (e.g., in the form of replying to the message, liking the message, etc.), when the user posts messages on the one or more websites. “Network impact” reflects the computed influence value of a person's engaged audience. In an embodiment, based on these three features, the processor 202 may determine the social influence metric associated with the user. It will be apparent to a person skilled in the art, that the social influence metric may be utilized by the organizations to focus on the users with high social influence, since such users may spread good or bad information about a product/service easily, and to a larger base of other users.

In an embodiment, the geographic location associated with the user denotes the location, from where the user posts the one or more messages and interact with other users, or with the user-representative. The processor 202 may extract the location of the user based on the content of the messages posted by the user. In an alternate embodiment, the processor 202 may determine geographic location associated with the user based on the geographic location mentioned in the social networking profile of the user. It will be apparent to a person skilled in the art that the geographic location associated with the user may be utilized by the organizations to identify the issues associated with their products/services in particular geographic areas.

In an embodiment, the U.S. patent application Ser. No. 13/833,858, filed on Mar. 15, 2013, and assigned to the same assignee (Xerox Corporation), and which herein incorporated by reference in its entirety discloses an example method for aggregating the conversations of the users in social media environment to determine various content-based metrics associated with the users.

At step 310, the users are categorized. The processor 202 may categorize the users in different categories based on the one or more attributes determined in conjunction with the step 308. The processor 202 may categorize the users in various categories, such as happy users, disgruntled users etc. Further, in an embodiment, the processor 202 may combine the one or more attributes and the one or more categories to sub-group the users. For example, the processor 202 may classify the user as “high influencing happy users”, “low influencing disgruntled users for category mobile recharges”, etc. It will be apparent to a person skilled in the art that the processor 202 categorizes the users associated with the product/service as well as the users associated with the competitor-product/competitor-service. The organizations associated with the product/service, or associated with the competitor-product/competitor-service may utilize the different categories of the users to target their, as well as competitor's users, accordingly.

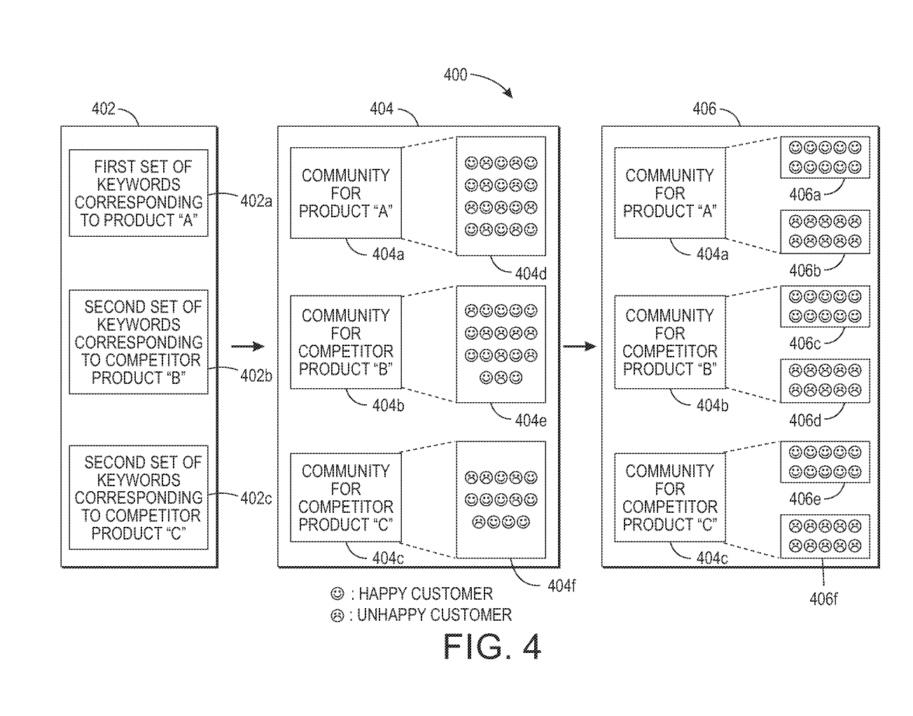

FIG. 4 is a block diagram 400 illustrating categorization of the users, in accordance with at least one embodiment of the present disclosure. The block diagram 400 includes different blocks 402-406, as depicted in the FIG. 4. The block 402 includes blocks 402a-c, the block 404 includes blocks 404a-f and the block 406 includes blocks 404a-c and blocks 406a-f. The block diagram 400 has been described in conjunction with the FIG. 3.

In accordance with the step 302, a set of keywords is received. As depicted by the block 402a, 402b, and 402c, respectively, a first set of keywords corresponding a product “A”, second set of keywords corresponding to a competitor product “B”, and second set of keywords corresponding to a competitor product “C” is received. Further details about receiving of the set of keywords has already been explained in conjunction with the FIG. 3.

In accordance with the step 304, a set of communities (including a first set of communities and a second set of communities) is identified based on the set of keywords. As depicted by the blocks 404a, 404b, and 404c, respectively, the determined communities correspond to the product “A”, competitor product “B”, and the competitor product “C’. Further, it can be observed that each of the communities includes happy users and unhappy users (as depicted by the blocks 404d-f).

In accordance with the step 306, the one or more conversations are determined. The aggregation of the one or more messages to generate the one or more conversations has already been discussed in conjunction with FIG. 3.

In accordance with the step 308, the one or more conversations are analyzed to obtain the one or more attributes. Analysis of the conversations has been discussed in conjunction with the FIG. 3.

In accordance with the step 310, the users are categorized into different categories. As depicted by the blocks 406a-f, users in each of the communities are grouped into different categories, such as happy users and the unhappy users. Further, it will be apparent to a person skilled in the art that the categorized users may further be sub-grouped using the one or more attributes, as discussed in conjunction with the FIG. 3.

The disclosed embodiments encompass numerous advantages. Identification of the satisfaction levels of the users in using different products/services has been an important business requirement for the organizations. To deal with such situations, organizations, typically, deploy CRM engagement tools, which can help the user-representatives in listening and resolving the user complaints. However, with the growing popularity of the social networking tools/applications, users usually form implicit (e.g., in the form of chats, posts, etc.) or explicit (e.g., by joining a research group) communities of these social networking tools/applications. Users use these social networking tools to express their opinions or review about various products/services, and to post different issues faced by them. Thus, the user-representatives may utilize these social networking tools to listen, understand, and to resolve user's issues by engaging with their users. The proposed disclosure understands the importance of social engagements of the users (with other users or with user-representatives) to identify their satisfaction or dissatisfaction for a product/service. Identification of the different categories of the users, by analyzing the conversations of those users, enables the organizations to target different users differently. For example, unhappy or dissatisfied users may be tried to retain by offering them with additional offers or services. In addition, identification of happy/unhappy users of the competitor-product/competitor-service may be utilized by the organizations to attract users from other organizations to increase the user base. In addition, the organizations may determine the product/service quality, as perceived by the users. Thus, this feedback may be utilized to improve the product/service offerings by the organization.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for categorizing users have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for categorizing users in one or more categories, the method comprising:
identifying, by one or more processors, a first set of communities and a second set of communities based on a set of keywords and one or more messages posted by at least the users on one or more websites, wherein the first set of communities corresponds to at least one of a product or a service, and wherein the second set of communities corresponds to at least one of a competitor-product or a competitor-service;
determining, by the one or more processors, one or more conversations associated with a user in at least one of the first set of communities or the second set of communities, based on the one or more messages, wherein each of the one or more conversations correspond to exchange of the one or more messages at least between the user and a user-representative; and
categorizing, by the one or more processors, the user in at least one category, from the one or more categories, based on one or more attributes determined from the one or more conversations, wherein the one or more attributes comprise at least one of a happiness score associated with the user, a conversation subject associated with the user, a social influence metric associated with the user, or a geographic location associated with the user, wherein
the happiness score is determined based on at least one of a start and end of the one or more conversations, a number of the one or more messages in each of the one or more conversations, time taken by the user-representative to reply to the one or more messages posted by the user, time taken by the user-representative to resolve the one or more issues, or a status of the one or more issues.

2. The method of claim 1, wherein the set of keywords comprises a first set of keywords corresponding to at least one of the product or the service, and a second set of keywords corresponding to at least one of the competitor-product or the competitor-service.

3. The method of claim 1, wherein the one or more websites comprise at least one of one or more social networking websites, a website associated with at least one of the product or the service, or a website associated with at least one of the competitor-product or the competitor-service.

4. The method of claim 1, wherein the at least one category comprises at least one of a happy user, or a disgruntled user.

5. The method of claim 4, wherein the conversation subject associated with the user is determinable of one or more reasons for the happiness or the disgruntlement.

6. The method of claim 1, wherein the one or more messages posted by the user comprise at least one of a review, a recommendation, or one or more issues about at least one of the product, the service, the competitor-product, or the competitor-service.

7. The method of claim 6, wherein the one or more messages comprise reply, by the user-representative, to the one or more messages posted by the user.

8. The method of claim 1, wherein the social influence metric associated with the user is indicative of at least one of activeness of the user in posting the one or more messages on the one or more websites, or influence of the one or more messages posted by the user on other users.

9. A system for categorizing users in one or more categories, the system comprising:
one or more processors configured to:
identify a first set of communities and a second set of communities based on a set of keywords and one or more messages posted by at least the users on one or more websites, wherein the first set of communities corresponds to at least one of a product or a service, and wherein the second set of communities corresponds to at least one of a competitor-product or a competitor-service;
determine one or more conversations associated with a user in at least one of the first set of communities or the second set of communities, based on the one or more messages, wherein each of the one or more conversations correspond to exchange of the one or more messages at least between the user and a user-representative; and
categorize the user in at least one category, from the one or more categories, based on one or more attributes determined from the one or more conversations, wherein the one or more attributes comprise at least one of a happiness score associated with the user, a conversation subject associated with the user, a social influence metric associated with the user, or a geographic location associated with the user, wherein
the happiness score is determined based on at least one of a start and end of the one or more conversations, a number of the one or more messages in each of the one or more conversations, time taken by the user-representative to reply to the one or more messages posted by the user, time taken by the user-representative to resolve the one or more issues, or a status of the one or more issues.

10. The system of claim 9, wherein the set of keywords comprises a first set of keywords corresponding to at least one of the product or the service, and a second set of keywords corresponding to at least one of the competitor-product or the competitor-service.

11. The system of claim 9, wherein the one or more websites comprise at least one of one or more social networking websites, a website associated with at least one of the product or the service, or a website associated with at least one of the competitor-product or the competitor-service.

12. The system of claim 9, wherein the at least one category comprises at least one of a happy user, or a disgruntled user.

13. The system of claim 12, wherein the conversation subject associated with the user is determinable of one or more reasons for the happiness or the disgruntlement.

14. The system of claim 9, wherein the one or more messages posted by the user comprise at least one of a review, a recommendation, or one or more issues about at least one of the product, the service, the competitor-product, or the competitor-service.

15. The system of claim 14, wherein the one or more messages comprise reply, by the user-representative, to the one or more messages posted by the user.

16. The system of claim 9, wherein the social influence metric associated with the user is indicative of at least one of activeness of the user in posting the one or more messages on the one or more websites, or influence of the one or more messages posted by the user on other users.

17. A computer program product for use with a computer, the computer program product comprising a non-transitory computer readable medium, wherein the non-transitory computer readable medium stores a computer program code for categorizing users in one or more categories, wherein the computer program code is executable by one or more processors to:
identify a first set of communities and a second set of communities based on a set of keywords and one or more messages posted by at least the users on one or more websites, wherein the first set of communities corresponds to at least one of a product or a service, and wherein the second set of communities corresponds to at least one of a competitor-product or a competitor-service;
determine one or more conversations associated with a user in at least one of the first set of communities or the second set of communities, based on the one or more messages, wherein each of the one or more conversations correspond to exchange of the one or more messages at least between the user and a user-representative; and
categorize the user in at least one category, from the one or more categories, based on one or more attributes determined from the one or more conversations, wherein the one or more attributes comprise at least one of a happiness score associated with the user, a conversation subject associated with the user, a social influence metric associated with the user, or a geographic location associated with the user, wherein
the happiness score is determined based on at least one of a start and end of the one or more conversations, a number of the one or more messages in each of the one or more conversations, time taken by the user-representative to reply to the one or more messages posted by the user, time taken by the user-representative to resolve the one or more issues, or a status of the one or more issues.
